(19) United States
(12) Patent Application Publication
(10) Pub. No.: US 2023/0104218 A1
(43) Pub. Date: Apr. 6, 2023

(54) SYSTEMS AND METHODS FOR SHARING CONTENT

(71) Applicant: Meta Platforms, Inc., Menlo Park, CA (US)

(72) Inventor: Robin Maxime Clediere, San Francisco, CA (US)

(21) Appl. No.: 16/057,772

(22) Filed: Aug. 7, 2018

(51) Int. Cl. G06Q 50/00; G06N 99/00

(52) U.S. Cl. CPC G06Q 50/01; G06N 99/005

(57) ABSTRACT

Systems, methods, and non-transitory computer-readable media can provide a scalable composer interface for creating and sharing content through a social networking system. A content item being accessed can be determined. At least one option for interacting with the content item can be predicted based at least in part on the content item being accessed. The at least one predicted option can be provided in the scalable composer interface, wherein the at least one predicted option is able to be selected to interact with the content item being accessed.

### FIELD OF THE INVENTION

The present technology relates to the field of content sharing. More particularly, the present technology relates to techniques for users to share content.

### BACKGROUND

Users often utilize computing devices for a wide variety of purposes. Users can use their computing devices to, for example, interact with one another, access media content, share media content, and create media content. In some cases, media content can be provided by members of a social network. The media content can include one or a combination of text, images, videos, and audio. The media content may be published to the social network for consumption by others.

### SUMMARY

Various embodiments of the present disclosure can include systems, methods, and non-transitory computer readable media configured to provide a scalable composer interface for creating and sharing content through a social networking system. A content item being accessed can be determined. At least one option for interacting with the content item can be predicted based at least in part on the content item being accessed. The at least one predicted option can be provided in the scalable composer interface, wherein the at least one predicted option is able to be selected to interact with the content item being accessed.

In an embodiment, determining the content item being accessed further comprises: determining a type of the content item being accessed, wherein the at least one predicted option is determined based at least in part on the type of the content item being accessed.

In an embodiment, the type of the content item corresponds to at least one of a post, a post that references external content, a post that solicits information, a post that includes a call-to-action, and a comment posted in reply to a post.

In an embodiment, determining the content item being accessed further comprises further comprises: determining subject matter included in the content item being accessed, wherein the at least one predicted option is determined based at least in part on the subject matter included in the content item being accessed.

In an embodiment, the subject matter includes at least one of text included with the content item, visual content included with the content item, or a combination thereof.

In an embodiment, the at least one option is predicted using a machine learning model that is trained to predict options based on a content item being composed or accessed.

In an embodiment, the systems, methods, and non-transitory computer readable media are configured to train a machine learning model for predicting the at least one option.

In an embodiment, the machine learning model is trained using training data that includes a number of training examples, and wherein each training example includes a set of features including at least a content item type, subject matter included in the content item, and a supervisory signal identifying one or more options to be predicted based on the set of features.

In an embodiment, the machine learning model is trained to predict the at least one option based in part on an identity of a user accessing the scalable composer interface.

In an embodiment, the systems, methods, and non-transitory computer readable media are configured to determine that a user accessing the scalable composer interface is creating a second content item to be shared through the social networking system; predict at least one option for composing the second content item; and provide the at least one predicted option in the scalable composer interface, wherein the at least one predicted option is able to be selected to create and share the content item.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example system including an example composer module, according to an embodiment of the present disclosure.

FIG. 2 illustrates an example options prediction module, according to an embodiment of the present disclosure.

FIGS. 3A-3B illustrate an example scalable composer interface, according to an embodiment of the present disclosure.

FIGS. 4A-4B illustrate another example scalable composer interface including a predicted option, according to an embodiment of the present disclosure.

FIG. 5 illustrates an example method, according to an embodiment of the present disclosure.

FIG. 6 illustrates a network diagram of an example system including an example social networking system that can be utilized in various scenarios, according to an embodiment of the present disclosure.

FIG. 7 illustrates an example of a computer system or computing device that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Approaches for Sharing Content

As mentioned, users often utilize computing devices for a wide variety of purposes. Users can use their computing devices to, for example, interact with one another, access media content, share media content, and create media content. In some cases, media content items can include postings from members of an online community or platform, such as a social networking system. The postings may include one or a combination of text, images, videos, and audio. The postings may be published to the social networking system for consumption by others.

Under conventional approaches, users can confront various challenges when composing content items (e.g., posts, comments) to be shared through a content provider (e.g., a social networking system). In general, users of a social networking system may compose posts to be shared with other users through the social networking system. Similarity, users of the social networking system may compose comments in response to posts shared by other users through the social networking system. Users can typically compose such content items using a conventional composer. For example, a conventional composer for creating posts or comments can include a content field and a virtual keyboard. A user accessing the composer can create a post by entering information such as text or emoji using the virtual keyboard. The entered information can then be reflected in the content field. Once satisfied with the post, the user can select an option to share the post through the social networking system.

Conventional composers have drawbacks that can harm user experience. For example, under conventional approaches, different composers may be provided to users of a social networking system depending on the type of content being created. That is, users creating one type of content item (e.g., posts) may be shown a composer with options for creating that type of content item (e.g., options for entering text, emoji, and interactive stickers). In another example, users creating another type of content item (e.g., a recommendation request) may be shown a different composer with options for creating that type of content item (e.g., options for creating recommendation requests). The need for different composers typically stems from the many options that are available to users depending on the type of content being created and shared. As a result, each composer is typically configured to create and share a particular type of content item and can include options for creating and sharing that particular type of content item. However, this need for different composers can create an inconsistent user experience throughout the social networking system. Further, a universal composer that includes options for creating all types of content items would potentially harm user experience due to the sheer number of options that may be presented to users when accessing the composer. Accordingly, user experience can suffer, thereby discouraging users from sharing content through the social networking system.

An improved approach rooted in computer technology overcomes the foregoing and other disadvantages associated with conventional approaches specifically arising in the realm of computer technology. In various embodiments, a scalable composer interface for creating and sharing various types of content items can be provided. The scalable composer interface can provide myriad options for creating and sharing content items such as options for inserting interactive stickers, inserting visual content (e.g., images, videos), and applying graphical effects, for example. In various embodiments, the scalable composer interface can be presented to users when composing a content item (e.g., creating a post) and when responding to posted content items (e.g., creating a comment in response to a post). In some embodiments, one or more options for composing a content item can be predicted and shown in the scalable composer interface when a user is composing a content item (e.g., creating a post). For example, a user composing a post may input text that specifically references another user (e.g., @username). In this example, a determination can be made that the user composing the content item may want to privately share the content item with the referenced user. Based on this determination, the scalable composer interface can provide (or suggest) an option for sharing the content item with the referenced user in an instant message (or some other private communication). The user composing the content item can select the provided option to share the content item with the referenced user in an instant message over a social networking system, for example. In some embodiments, one or more options for interacting with a content item can be predicted and shown in the scalable composer interface when a user is responding to a content item (e.g., creating a comment in response to a post). For example, a determination can be made that users that view a particular type of post are likely to respond to the post with a comment that includes an interactive sticker. In this example, the scalable composer interface can provide an easily accessible option for responding to the post with an interactive sticker. For example, the option can be accessible directly from the scalable composer interface without requiring users to navigate a separate options menu. The improved approaches therefore provide a consistent composer interface that can be used to create and share various types of content items. Further, the improved approaches also improve the user experience by intelligently predicting which options are relevant to users and prioritizing access to those predicted options in the composer interface. More details relating to the disclosed technology are provided below.

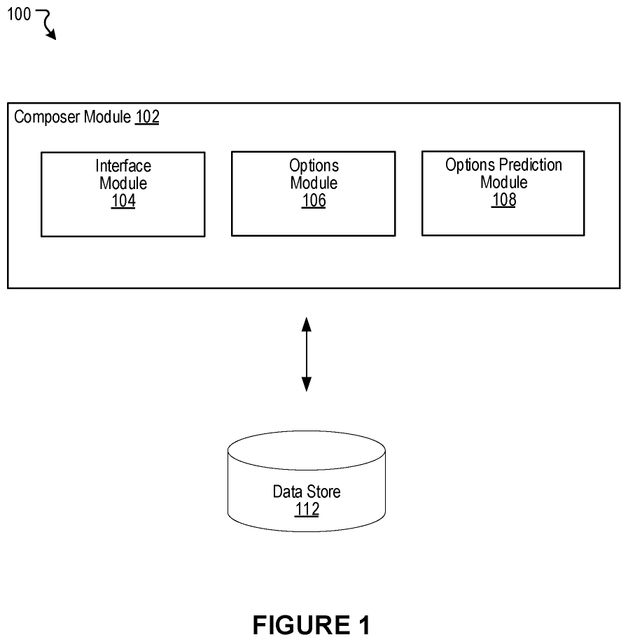

FIG. 1 illustrates an example system 100 including an example composer module 102, according to an embodiment of the present disclosure. As shown in the example of FIG. 1, the composer module 102 can include an interface module 104, an options module 106, and an options prediction module 108. In some instances, the example system 100 can include at least one data store 112. The components (e.g., modules, elements, etc.) shown in this figure and all figures herein are exemplary only, and other implementations may include additional, fewer, integrated, or different components. Some components may not be shown so as not to obscure relevant details.

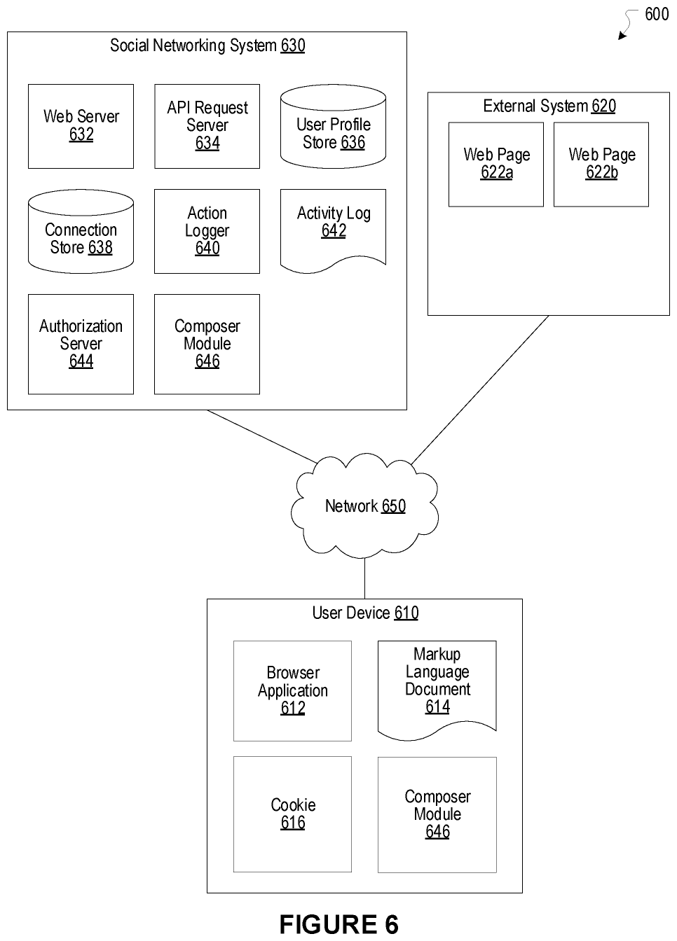

In some embodiments, the composer module 102 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some cases, the composer module 102 or at least a portion thereof can be implemented using one or more computing devices or systems that include one or more servers, such as network servers or cloud servers. In some instances, the composer module 102 can, in part or in whole, be implemented within or configured to operate in conjunction with a social networking system (or service), such as the social networking system 630 of FIG. 6. In some instances, the composer module 102 can be, in part or in whole, implemented within or configured to operate in conjunction or be integrated with a client computing device, such as the user device 610 of FIG. 6. For example, the composer module 102 can be implemented as or within a dedicated application (e.g., app), a program, or an applet running on a user computing device or client computing system. The application incorporating or implementing instructions for performing some, or all, functionality of the composer module 102 can be created by a developer. The application can be provided to or maintained in a repository. In some cases, the application can be uploaded or otherwise transmitted over a network (e.g., Internet) to the repository. For example, a computing system (e.g., server) associated with or under control of the developer of the application can provide or transmit the application to the repository. The repository can include, for example, an “app” store in which the application can be maintained for access or download by a user. In response to a command by the user to download the application, the application can be provided or otherwise transmitted over a network from the repository to a computing device associated with the user. For example, a computing system (e.g., server) associated with or under control of an administrator of the repository can cause or permit the application to be transmitted to the computing device of the user so that the user can install and run the application. The developer of the application and the administrator of the repository can be different entities in some cases, but can be the same entity in other cases. It should be understood that many variations are possible.

The composer module 102 can be configured to communicate and/or operate with the at least one data store 112, as shown in the example system 100. The at least one data store 112 can be configured to store and maintain various types of data. For example, the data store 112 can store information describing various content that has been shared by users of a social networking system. In some implementations, the at least one data store 112 can store information associated with the social networking system (e.g., the social networking system 630 of FIG. 6). The information associated with the social networking system can include data about users, social connections, social interactions, locations, geo-fenced areas, maps, places, events, pages, groups, posts, communications, content, feeds, account settings, privacy settings, a social graph, and various other types of data. In some implementations, the at least one data store 112 can store information associated with users, such as user identifiers, user information, profile information, user specified settings, content produced or posted by users, and various other types of user data.

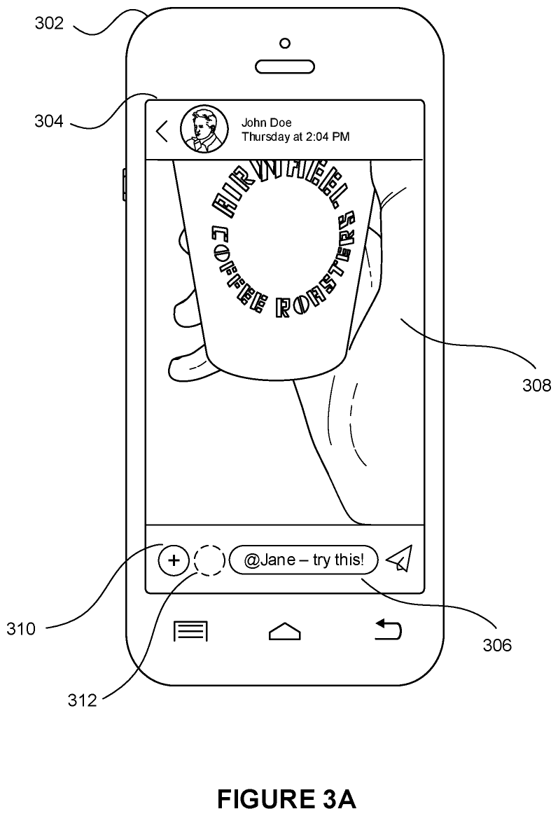

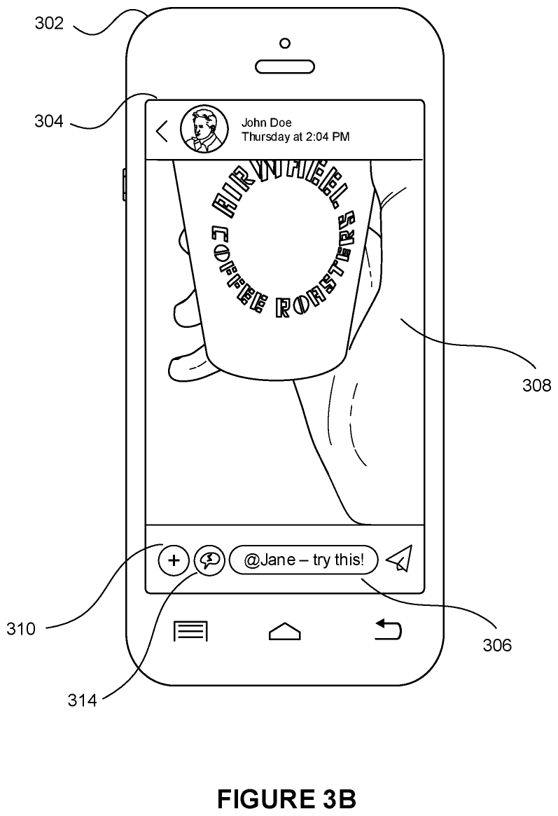

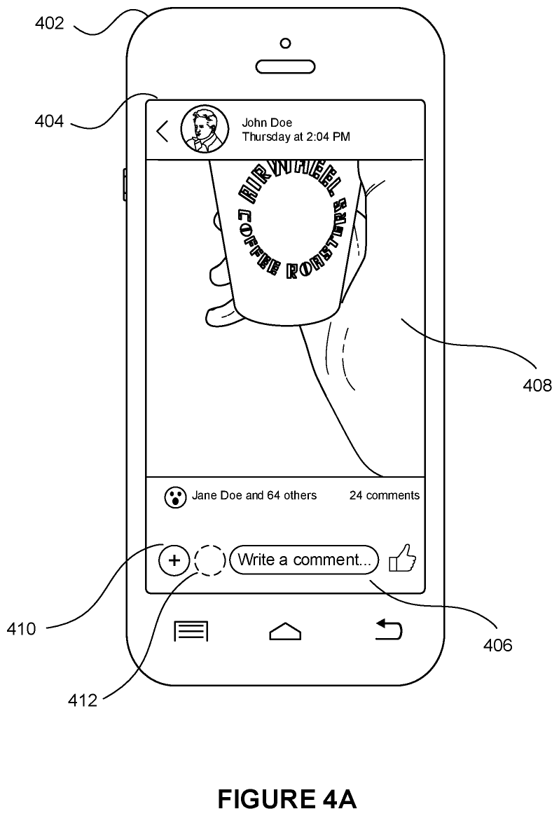

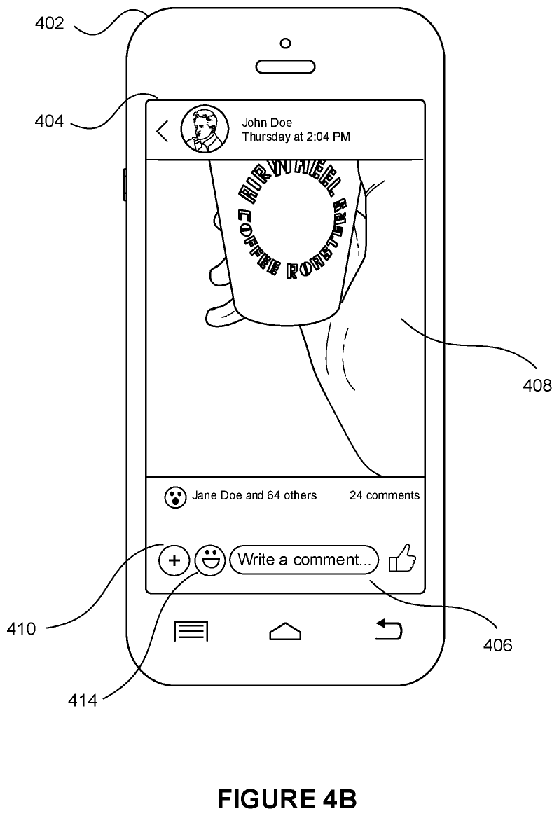

In various embodiments, the interface module 104 can be configured to provide a scalable composer interface through which users can create and share content items (e.g., posts, comments, etc.). For example, shared content items can include text, visual content (e.g., images, videos, graphical text, animated text, etc.), and combinations thereof. The scalable composer interface may be presented through a display screen of a computing device. A user operating the computing device can interact with the interface using various touchscreen gestures or an external apparatus, for example. In some embodiments, the interface can include a content field, a virtual keyboard, and options for creating and sharing content. A user accessing the interface can create a content item, for example, by entering text using the virtual keyboard. In this example, the entered text can be visualized in the content field. In some embodiments, the interface can be used to compose different types of content items. For example, in some embodiments, a user accessing the interface can compose different types of content items such as a post that may include text and visual content, a post that references external content (e.g., blog post, news article, etc.), a post that solicits information (e.g., a questionnaire, a poll, a quiz, a recommendation, etc.), a post that includes a call-to-action (CTA), or a comment composed in response to a post by another user, to name some examples. More details regarding the scalable composer interface will be provided below with reference to FIGS. 3A-3B and 4A-4B.

The options module 106 can provide myriad options for creating and sharing content. These options can be accessed in the interface provided by the interface module 104. For example, the options module 106 can provide an option to insert an interactive sticker in a content item (e.g., a post or comment) being composed, an option to access a camera interface for capturing content (e.g., images, video, audio) to be included in a content item being composed, an option to apply graphical overlays to a content item being composed, an option to insert GIFs in a content item being composed, an option to solicit information from other users (e.g., a questionnaire, a poll, a quiz, a recommendation, etc.), an option to message a content item directly to a user (e.g., instant message), and an option to remix (e.g., visually modify) content (e.g., images, videos), to name some examples. In some embodiments, the options module 106 can organize such options in an options menu that is accessible through the interface provided by the interface module 104.

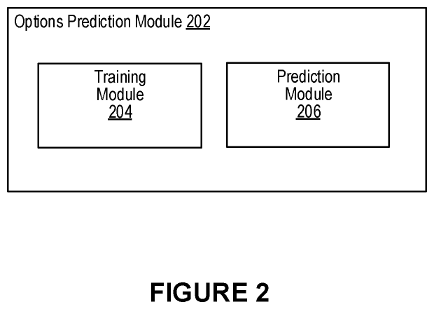

The options prediction module 108 can be configured to predict which option (or options) users are likely to select when creating or interacting with content items. The predicted option (or options) can be shown and made accessible within the interface provided by the interface module 104. More details regarding the options prediction module 108 will be provided below with reference to FIG. 2.

FIG. 2 illustrates an example options prediction module 202, according to an embodiment of the present disclosure. The options prediction module 202 can predict options that users are likely to select when accessing or creating content items. Some examples of options that may be predicted and included in a scalable composer interface include a like option, a comment option, a share option, an option to respond to a content item with a comment, an option to respond to a content item with a comment that includes an interactive sticker, an option to insert visual content (e.g., images, videos, GIFs, interactive stickers, etc.) in a content item being composed, an option to create a content item that solicits information from other users (e.g., a questionnaire, a poll, a quiz, a recommendation, etc.), an option to message a content item directly to a user (e.g., instant message), and an option to remix (or visually modify) any visual content included in a content item being accessed. Other options for creating and sharing content items are contemplated by the present technology. In some embodiments, the options prediction module 108 of FIG. 1 can be implemented with the options prediction module 202. As shown in the example of FIG. 2, the options prediction module 202 can include a training module 204 and a prediction module 206.

The training module 204 can be configured to determine training data that can be used to train a model (e.g., a machine learning model) for predicting options to include in a scalable composer interface. In some embodiments, the training data can include a number of training examples. Each training example can include a set of features such as a type of content item that was accessed (or created), subject matter included in the content item (e.g., text, keywords, visual content, etc.), or a combination thereof. Further, each training example can include a supervisory signal identifying an option (or options) to be predicted based on the set of features. For example, a training example can include a first feature identifying a type of content item (e.g., a post for soliciting recommendations), a second feature identifying text included in the content item, a third feature identifying visual content included with the content item (e.g., emoji, interactive stickers, images, videos, etc.), and a supervisory signal identifying one or more options to be predicted based on the features. In some embodiments, the training examples can be generated from user data. For example, a training example can include a first feature identifying a type of content item that was accessed (or created) by a given user, a second feature identifying text included in the content item, a third feature identifying visual content included with the content item, and a supervisory signal identifying one or more options that were selected by the user when accessing (or creating) the content item. In some embodiments, options can be predicted for specific users or specific groups of users. In such embodiments, training examples can include an additional feature identifying a user who accessed (or created) a content item (e.g., a user identifier, group identifier) in addition to some or all of the features described above. In some embodiments, the options predicted and included in a scalable composer interface may vary depending on whether a user is composing a content item (e.g., creating a post) or whether a user is responding to a posted content item (e.g., creating a comment in response to a post). In such embodiments, the machine learning model can be trained to consider this distinction when predicting options. Many variations are possible. In various embodiments, the training module 204 can use the training data to train a model (e.g., machine learning model) for predicting options using generally known approaches for training and implementing a machine learning model. For example, in some embodiments, the training module 204 can use the training data to train a machine learning model that implements linear regression.

In some embodiments, the prediction module 206 can determine options to include in a scalable composer interface. That is, the prediction module 206 can use the model generated by the training module 204 to predict options to include in the scalable composer interface. For example, when a user is composing a content item (e.g., creating a post), the prediction module 206 can determine a set of features describing the content item being created. For example, these features can include a type of content item being created, text included with the content item, visual content included with the content item, or a combination thereof. The prediction module 206 can provide this set of features to the model as inputs. The prediction module 206 can then obtain information describing one or more options for composing the content item as predicted by the model based on the set of inputted features. In some embodiments, one or more of the predicted options can be included in a scalable comment interface that is presented to the user. The user can select these predicted options to create (or share) the content item. For example, a user composing a post may input text that references a movie and includes one or more keywords that that suggest the text includes a spoiler (e.g., “spoiler” or “spoiler alert”). In this example, the model may predict an option for applying a graphical effect that masks the spoiler from plain view. The predicted option can then be included in a scalable composer interface being accessed by the user. In another example, a user composing a content item (e.g., post) may input text that references another user (e.g., @username). In this example, the model may predict an option to share the content item with the referenced user in a message (e.g., instant message) rather than a post. The predicted option can then be included in a scalable composer interface being accessed by the user. Many variations are possible. The prediction module 206 can also predict options for responding to a content item being accessed (e.g., posting a comment) using the model generated by the training module 204. For example, when a user is accessing a given content item (e.g., viewing a post), the prediction module 206 can determine a set of features describing the content item being accessed. As discussed above, these features can include, for example, a type of content item being accessed, text included with the content item, visual content included with the content item, or a combination thereof. The prediction module 206 can provide this set of features to the model as inputs. The prediction module 206 can then obtain information describing one or more options for responding to the accessed content item as predicted by the model based on the set of inputted features. In some embodiments, one or more of the predicted options can be included in a scalable comment interface that is presented to the user. The user can select these predicted options to respond to the content item. For example, a user may be accessing a posted news story. In this example, the model may predict an option for responding to the posted news story with a reaction (e.g., happy, sad, excited, etc.). The predicted option can then be included in a scalable composer interface being accessed by the user. In another example, a user may be accessing a post that is soliciting restaurant recommendations. In this example, the model may predict an option to respond to the post with a recommendation. For example, the user can select the predicted option to respond to the post with a recommendation along with one or more hyperlinks associated with the recommendation. Many variations are possible.

FIG. 3A illustrates an example scalable composer interface 304 that can be implemented by the composer module 102, according to an embodiment of the present disclosure. In this example, the interface 304 is presented through a display screen of a computing device 302 that is configured to interact with a social networking system. Further, the interface 304 may be provided through an application (e.g., a web browser, a social networking application, etc.) running on the computing device 302. The interface 304 includes options for creating and sharing content items. For example, the interface 304 includes a field 306 for inputting text to be included with a post 308 being composed. The interface 304 also includes an option 310 for accessing an options menu that includes various options for creating and sharing content items. For example, the options menu can include options for inserting interactive stickers, inserting visual content (e.g., images, videos), applying graphical effects, among many other options. In some embodiments, the interface 304 can include one or more predicted options 312. As mentioned, such options may be determined or predicted, for example, using a trained machine learning model. For example, such options may be predicted based on, for example, text included with the post 308 being composed, visual content included with the post 308, or combinations thereof. In FIG. 3A, a user interacting with the interface 304 has inputted text (“@Jane—try this!”) to be included with the post 308 being composed. As shown, the text references another user “Jane”. In this example, a prediction can be made that the user may want to share the post 308 in a private message (e.g., instant message) with the referenced user rather than publishing the post 308 for distribution to many users. Based on this prediction, an option 314 for sharing the post 308 with the referenced user in a private message can be automatically provided for selection without need for extensive navigation, as illustrated in the example of FIG. 3B. Many variations are possible.

FIG. 4A illustrates another example scalable composer interface 404 that can be implemented by the composer module 102, according to an embodiment of the present disclosure. In this example, the interface 404 is presented through a display screen of a computing device 402 that is configured to interact with a social networking system. Further, the interface 404 may be provided through an application (e.g., a web browser, a social networking application, etc.) running on the computing device 402. The interface 404 includes options for responding to (or interacting with) posted content items. For example, the interface 404 includes a field 406 for entering a comment in response to a post 408 being accessed. The interface 404 also includes an option 410 for accessing an options menu that includes various options as described above. In some embodiments, the interface 404 can include one or more predicted options 412. As mentioned, such options may be determined or predicted, for example, using a trained machine learning model. In FIG. 4A, a prediction can be made that a user interacting with the post 408 is likely to respond to the post 408 with a certain reaction (e.g., smiley). Based on this prediction, an option 414 for responding to the post 408 with the certain reaction can be automatically provided to enhance user experience, as illustrated in the example of FIG. 4B. Many variations are possible.

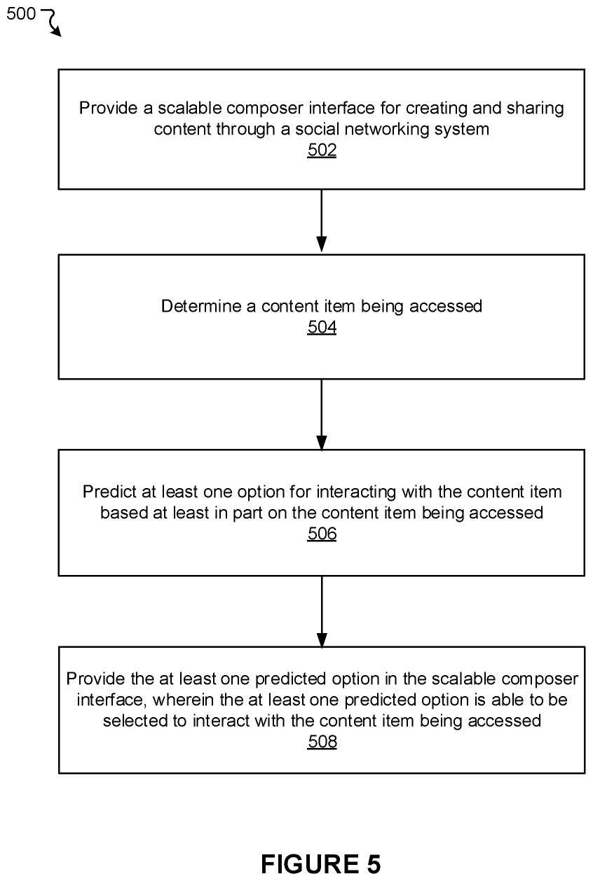

FIG. 5 illustrates an example method 500, according to an embodiment of the present disclosure. It should be appreciated that there can be additional, fewer, or alternative steps performed in similar or alternative orders, or in parallel, within the scope of the various embodiments discussed herein unless otherwise stated.

At block 502, a scalable composer interface for creating and sharing content through a social networking system can be provided. At block 504, a content item being accessed can be determined. At block 506, at least one option for interacting with the content item can be predicted based at least in part on the content item being accessed. At block 508, the at least one predicted option can be provided in the scalable composer interface, wherein the at least one predicted option is able to be selected to interact with the content item being accessed.

It is contemplated that there can be many other uses, applications, and/or variations associated with the various embodiments of the present disclosure. For example, in some cases, user can choose whether or not to opt-in to utilize the disclosed technology. The disclosed technology can also ensure that various privacy settings and preferences are maintained and can prevent private information from being divulged. In another example, various embodiments of the present disclosure can learn, improve, and/or be refined over time.

### Social Networking System—Example Implementation

FIG. 6 illustrates a network diagram of an example system 600 that can be utilized in various scenarios, in accordance with an embodiment of the present disclosure. The system 600 includes one or more user devices 610, one or more external systems 620, a social networking system (or service) 630, and a network 650. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices (or systems) that can receive input from a user and transmit and receive data via the network 650. In one embodiment, the user device 610 is a conventional computer system executing, for example, a Microsoft Windows compatible operating system (OS), Apple OS X, and/or a Linux distribution. In another embodiment, the user device 610 can be a computing device or a device having computer functionality, such as a smart-phone, a tablet, a personal digital assistant (PDA), a mobile telephone, a laptop computer, a wearable device (e.g., a pair of glasses, a watch, a bracelet, etc.), a camera, an appliance, etc. The user device 610 is configured to communicate via the network 650. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 650, which may comprise any combination of local area and/or wide area networks, using wired and/or wireless communication systems.

In one embodiment, the network 650 uses standard communications technologies and protocols. Thus, the network 650 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 650 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 650 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the Silverlight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 650. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content. As discussed previously, it should be appreciated that there can be many variations or other possibilities.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects a particular other user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing interactions between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and interactions with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 650.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and interactions.

The social networking system 630 also includes user-generated content, which enhances a user's interactions with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the interaction of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the interactions and connections among those objects, providing a rich source of socially relevant information.

The web server 632 links the social networking system 630 to one or more user devices 610 and/or one or more external systems 620 via the network 650. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 650, and the API request server 634 receives the API request. The API request server 634 processes the request by calling an API associated with the API request to generate an appropriate response, which the API request server 634 communicates to the external system 620 via the network 650. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's interaction with an external system 620 from the web server 632. In this example, the external system 620 reports a user's interaction according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing interactions between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list”. External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the social networking system 630 can include a composer module 646. The composer module 646 can, for example, be implemented as the composer module 102 of FIG. 1. In some embodiments, the composer module 646, in whole or in part, is additionally or alternatively implemented in the user device 610. As discussed previously, it should be appreciated that there can be many variations or other possibilities.

### Hardware Implementation

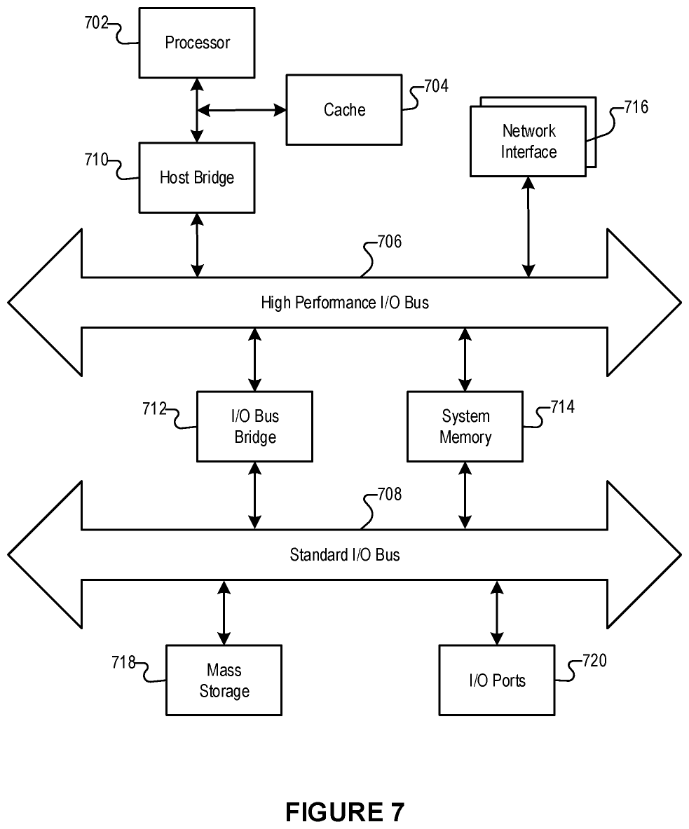

The foregoing processes and features can be implemented by a wide variety of machine and computer system architectures and in a wide variety of network and computing environments. FIG. 7 illustrates an example of a computer system 700 that may be used to implement one or more of the embodiments described herein in accordance with an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 720, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module”, with processor 702 being referred to as the “processor core”. Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

1. A computer-implemented method comprising:
providing, by a computing system, a scalable composer interface that includes an option to access a menu of options;
determining, by the computing system, a content item being composed in the scalable composer interface;
predicting, by the computing system, at least one option to be included in the scalable composer interface based at least in part on a machine learning model that evaluates the content item being composed, wherein the at least one option is predicted based at least in part on (i) a set of features associated with the content item and (ii) a user composing the content item, and wherein the at least one option can be selected to insert content into the content item, wherein the predicting the at least one option comprises:
training, by the computing system, the machine learning model based on training data that includes training examples including supervisory signals associated with options selected by users to insert content into content items; and
providing, by the computing system, an updated scalable composer interface that includes (i) the at least one option and (ii) the option to access the menu of options.

2. The computer-implemented method of claim 1, wherein the content item includes a post and predicting the at least one option further comprises:
determining, by the computing system, a type of the post, wherein the at least one option is determined based at least in part on the type of the post.

3. The computer-implemented method of claim 2, wherein the type of the post corresponds to at least one of a post that references external content, a post that solicits information, or a post that includes a call-to-action.

4. The computer-implemented method of claim 1, wherein predicting the at least one option further comprises:
determining, by the computing system, subject matter included in the content item, wherein the at least one option is determined based at least in part on the subject matter included in the content item, wherein the subject matter includes at least one of text included with the content item, visual content included with the content item, or a combination thereof.

5. (canceled)

6. (canceled)

7. (canceled)

8. The computer-implemented method of claim 1, wherein the training examples further include at least content item types and subject matter included in the content items.

9. The computer-implemented method of claim 7, wherein the machine learning model is trained to predict the at least one option based in part on an identity of the user accessing the scalable composer interface.

10. The computer-implemented method of claim 1, further comprising:
determining, by the computing system, a selection of an option in the scalable composer interface to compose a second content item;
predicting, by the computing system, at least one option for the second content item; and
providing, by the computing system, the at least one option in the scalable composer interface, wherein the at least one predicted option can be selected to create and share the second content item.

11. A system comprising:
at least one processor; and
a memory storing instructions that, when executed by the at least one processor, cause the system to perform:
providing a scalable composer interface that includes an option to access a menu of options;
determining a content item being composed in the scalable composer interface;
predicting at least one option to be included in the scalable composer interface based at least in part on a machine learning model that evaluates the content item being composed, wherein the at least one option is predicted based at least in part on (i) a set of features associated with the content item and (ii) a user composing the content item, and wherein the at least one option can be selected to insert content into the content item, wherein the predicting the at least one option comprises:
training the machine learning model based on training data that includes training examples including supervisory signals associated with options selected by users to insert content into content items; and
providing an updated scalable composer interface that includes (i) the at least one option and (ii) the option to access the menu of options.

12. The system of claim 11, wherein predicting the at least one option further causes the system to perform:
determining a type of the post, wherein the at least one option is determined based at least in part on the type of the post.

13. The system of claim 12, wherein the type of the post corresponds to at least one of a post that references external content, a post that solicits information, or a post that includes a call-to-action.

14. The system of claim 11, wherein predicting the at least one option further causes the system to perform:
determining subject matter included in the content item, wherein the at least one option is determined based at least in part on the subject matter included in the content item, wherein the subject matter includes at least one of text included with the content item, visual content included with the content item, or a combination thereof.

15. (canceled)

16. A non-transitory computer-readable storage medium including instructions that, when executed by at least one processor of a computing system, cause the computing system to perform a method comprising:
providing a scalable composer interface that includes an option to access a menu of options;
determining a content item being composed in the scalable composer interface;
predicting at least one option to be included in the scalable composer interface based at least in part on a machine learning model that evaluates the content item being composed, wherein the at least one option is predicted based at least in part on (i) a set of features associated with the content item and (ii) a user composing the content item, and wherein the at least one option can be selected to insert content into the content item, wherein the predicting the at least one option comprises:
training the machine learning model based on training data that includes training examples including supervisory signals associated with options selected by users to insert content into content items; and
providing an updated scalable composer interface that includes (i) the at least one option and (ii) the option to access the menu of options.

17. The non-transitory computer-readable storage medium of claim 16, wherein predicting the at least one option further causes the computing system to perform:
determining a type of the post, wherein the at least one option is determined based at least in part on the type of the post.

18. The non-transitory computer-readable storage medium of claim 17, wherein the type of the post corresponds to at least one of a post that references external content, a post that solicits information, or a post that includes a call-to-action.

19. (canceled)

20. (canceled)

21. The computer-implemented method of claim 1, wherein the content for insertion into the content item includes at least one of an interactive sticker, an image, a video, or a graphical effect.

22. The computer-implemented method of claim 1, wherein the content item is a post for posting on a social networking system and the at least one option of the updated scalable composer interface is selected to insert the content into the post.

23. The computer-implemented method of claim 1, wherein the at least one option is predicted when the user is creating the content item.

24. The computer-implemented method of claim 23, wherein the at least one option is predicted after the user enters text during creation of the content item.

25. The computer-implemented method of claim 1, wherein
the at least one option further includes a second option to access a camera interface,
the training the machine learning model is further based on training data that includes training examples including supervisory signals associated with options selected by users to access camera interfaces, and
the updated scalable content interface includes the second option.
